(19) United States
(12) Patent Application Publication
(10) Pub. No.: US 2018/0315080 A1
(43) Pub. Date: Nov. 1, 2018

(54) System and Method for Verifying Completion of an Activity

(71) Applicant: Matthew LEWIS, Etobicoke (CA)

(72) Inventors: Matthew LEWIS, Etobicoke (CA); Brad ALLEN, Toronto (CA)

(73) Assignee: Matthew LEWIS, Etobicoke (CA)

(21) Appl. No.: 15/940,272

(22) Filed: Mar. 29, 2018

Related U.S. Application Data
(63) Continuation of application No. 14/335,654, filed on Jul. 18, 2014.
Application No. 14/335,654 is a continuation of application No. PCT/CA2013/050038, filed on Jan. 21, 2013.
(60) Provisional application No. 61/588,409, filed on Jan. 19, 2012.

(51) Int. Cl. G06Q 30/02

(52) U.S. Cl. CPC G06Q 30/0248; G06Q 30/02

(57) ABSTRACT

A system and method for verifying completion of an activity are provided. The system comprises a scanner operable to obtain token data obtainable based on completion of an activity; and a server operable to obtain the token data from the scanner to verify completion of the activity. The method comprises obtaining token data from completion of an activity and providing the token data to a server to verify completion of the activity.

### CROSS-REFERENCE TO RELATED APPLICATIONS

This application is a continuation of U.S. application Ser. No. 14/335,654 filed on Jul. 18, 2014, which is a continuation of International PCT Application No. PCT/CA2013/050038 filed on Jan. 21, 2013, which claims priority from U.S. Provisional Application No. 61/588,409 filed on Jan. 19, 2012, all of which are incorporated herein by reference.

### FIELD OF THE INVENTION

The following relates generally to verifying and rewarding completion of an activity.

### BACKGROUND

Consumers are increasingly exposed to advertisements in various physical spaces. Advertisers such as a vendor, manufacturer or service provider may advertise on posters and billboards. Advertisers further employ various means to measure the impact of advertisement, such as by conducting surveys. However, surveys are delayed and expensive.

Advertisements are typically attempts to drive consumer behaviour. This is why advertisers initiate promotions and coupons. Setting up these promotions and coupons is costly and, furthermore, there are few ways for advertisers to direct promotions and coupons to the consumers that would most react according to the advertisers' intent.

It is an object of the present invention to mitigate or obviate at least one of the above disadvantages.

### SUMMARY

A system for verifying completion of an activity is provided. The system comprises a scanner operable to obtain token data obtainable based on completion of an activity and a server operable to obtain the token data from the scanner to verify completion of the activity. The system may further comprise a mobile device comprising an activity data module, the mobile device being in communication with the scanner, a database operable to store activity information, user information and vendor information, and a server in communication with the database and with the mobile device, the server comprising an activity data module.

In one aspect, the system further comprises an activity data module on the mobile device operable to process the token data to generate an activity identifier. The activity data module may further be operable to provide the activity identifier to an activity data module on the server. The activity data module on the server may be operable to verify the completion of the activity.

In another aspect, the activity data module on the server is operable to compare the activity identifier to one or more predetermined activity conditions stored in the database to verify whether the activity identifier meets the one or more predetermined activity conditions.

In yet another aspect, the system further comprises a reward module operable to determine whether the verified activity meets one or more reward conditions. Upon determining that the activity meets the one or more reward conditions, the reward module provides a reward to the user.

In yet another aspect, a method of verifying completion of an activity is provided. The method comprises obtaining token data from completion of an activity; and providing the token data to a server to verify completion of the activity.

In yet another aspect, a method of verifying completion of an activity is provided. A user scans a token with a scanner and the scanner provides the token data to an activity data module in a mobile device. The activity data module processes the token data to generate an activity identifier, which the activity data module then provides to an activity data module on a server. The activity data module on the server compares the activity identifier to one or more predetermined activity conditions. The activity data module on the server verifies whether the activity identifier meets the one or more predetermined activity conditions.

In yet another aspect, a reward module determines whether the verified activity meets one or more reward conditions. Upon determining that the activity meets the one or more reward conditions, the reward module provides a reward to the user.

### BRIEF DESCRIPTION OF THE DRAWINGS

Embodiments will now be described by way of example only with reference to the appended drawings wherein:

FIG. 1 is a block diagram illustrating a system in accordance with the present invention;

FIG. 2 is a block diagram illustrating a mobile device in accordance with the present invention;

FIG. 3 is a block diagram illustrating a server in accordance with the present invention;

FIG. 4 is an example flow diagram illustrating a method of a user providing an activity identifier to a server;

FIG. 5 is an example flow diagram illustrating a method of a user providing an activity identifier and a personal identifier to a server;

FIG. 6 is an example flow diagram illustrating a method of a user scanning an advertisement to receive a reward;

FIG. 7 is an example flow diagram illustrating a method of a mobile device providing an activity identifier to a server and receiving an advertisement relating to the activity identifier;

FIG. 8 is an example flow diagram illustrating a method of a mobile device providing an activity identifier to a server and the server rewarding a user;

FIG. 9 is an example flow diagram illustrating a method of a mobile device providing an activity identifier to a server and the server validating the activity identifier; and

FIG. 10 is an example flow diagram illustrating a method of mobile device providing an activity identifier to a server and the user being rewarded for consenting to publish the activity identifier.

### DETAILED DESCRIPTION OF THE DRAWINGS

A system and method are provided for verifying completion of an activity. In one aspect, the system and method further enable a reward to be provided for such verification. The system enables a vendor to monitor and/or verify user activity and reward activity that is desirable to that vendor. The vendor may be a service provider, a manufacturer, a retail outlet, or any other entity that has an interest in encouraging particular activities by a user or users. By way of example, the activities for which the vendor provides a reward may comprise scanning an advertisement, purchasing a product, publishing purchase data, visiting a particular store, publishing information relating to a product, etc.

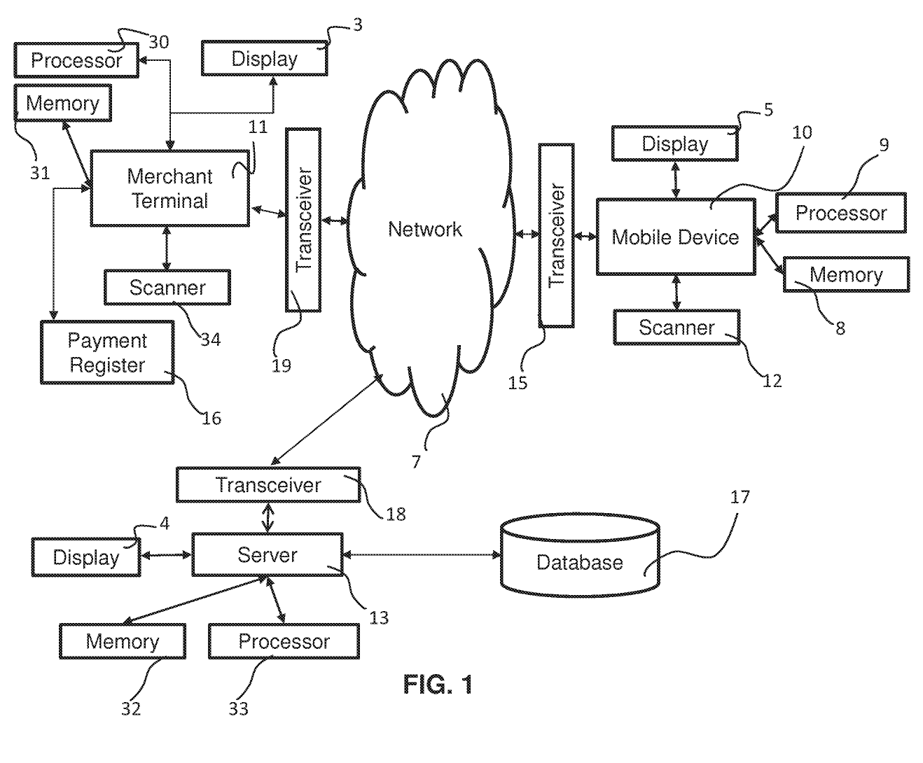

Turning to FIG. 1, a system operable to verify and reward desired user activity is shown. The system may comprise a mobile device 10, a server 13 and a vendor terminal 11. Each of the mobile device 10, server 13 and vendor terminal 11 may comprise a transceiver operable to link the mobile device 10, server 13 or vendor terminal 11, as the case may be, to a network 7. The network 7 may, for example, be the Internet. Each of the mobile device 10, vendor terminal 11, or server 13 may also comprise a display, and/or be linked to a display.

The mobile device 10 may be controlled by a user. The mobile device 10 may comprise a processor 9 and a memory 8. The memory 8 may have stored thereon instructions, which when executed by the processor, provide the functionality described herein. The mobile device 10 may also comprise a display 5 and/or be linked to a display 5.

The mobile device 10 may be a computer, such as a desktop computer, a laptop computer, a smartphone, or any other computer device. The mobile device 10 may further comprise a display 5 or may be linked to a display 5. The mobile device 10 further comprises a transceiver 15 that is operable to link the mobile device 10 to a network 7.

The mobile device 10 comprises, or may be linked to, a scanner 12 which is operable to obtain token data and provide token data to the mobile device 10. The scanner 12 may comprise a visual scanner. The scanner may further comprise a short range wireless scanner, for example, a radio frequency identification (RFID) scanner or near field communication (NFC) scanner. The scanner 12 may further comprise a combination of scanners, for example, a digital camera and a NFC module. It will be appreciated that the scanner could be any visual, audio, electronic, magnetic, thermal, mechanical, or other scanner. For example, the scanner may be a digital camera or a barcode scanner.

The server 13 administers a verification and reward service. The server 13 enables a vendor to verify completion of an activity by a user. The server 13 obtains information from the mobile device 10 relating to the completion the activity and provides the information to the vendor. The vendor may also provide an incentive for a user to complete a particular activity by providing the server with conditions under which a reward is provided to a user. If a user completes the incentivised activity, and the server verifies that the activity has been completed, the server may provide the user with a reward.

The server 13 further comprises a transceiver 18 operable to link the server to the network 7. The server 13 further comprises, or may be linked to, a processor 33 and a memory 32. The memory 32 may have stored thereon instructions, which when executed by the processor, provide the functionality described herein. The server 13 comprises or is linked to a database 17, which is operable to store activity information, user information and vendor information. It can be appreciated that the server may be a computer, a set of distributed computers, a cloud-based server or any other device linked to the network and able to perform the steps set out herein.

The mobile device 10 may be operable to provide product information and user information to the server 13 over the network 7, as is further described herein.

A vendor terminal 11 may further comprise a transceiver 19 linked to the network 7. The vendor terminal 11 may be, for example, a point of sale (POS) terminal, a desktop computer, or a mobile electronic device such as a smartphone, tablet, laptop or computer. The vendor terminal 11 may further be provided with a scanner 34. The vendor terminal 11 may be provided with a display 3. The vendor terminal may be provided with a memory 31 and a processor 30. The memory may have stored thereon instructions, which when executed by the processor, provide the functionality described herein. Similarly to the scanner 12 on the mobile device 10, the scanner 12 on the vendor terminal 11 may comprise a barcode scanner, a digital camera, an RFID scanner, etc.

The vendor terminal 11 may comprise a payment register 16 which receives payments from users. For example, the payment register 16 may comprise a credit card payment module, a debit card payment module, an NFC payment module, a cash register, etc. The payment register 16 may be operable to provide the vendor terminal 11 with payment information. The payment information may comprise the date and time of the transaction, the total transaction value, components of the transaction, the method of payment, information relating to discounts, and information relating to the user that is accessible through the payment method.

The vendor terminal 11 may be operable to provide purchase data and user data to the server 13 via the network 7.

The database 17 may comprise a vendor information table, an activity information table, a personal information table, a reward allocation table, a reward condition table, an advertisement table, and an advertisement condition table. The tables may be individually stored on the database or any combination of the aforementioned tables may be combined.

The vendor information table comprises information relating to vendors. For example, the vendor information table may comprise information relating to the size of a vendor, the vendor's location, a list of the vendor's products, etc.

The activity information table may comprise, for example, information relating to a list of activities that a vendor desires users to complete, or conditions that must be satisfied to verify the activity.

The personal information table may comprise, for example, information relating to individual users including demographic information, social media information, a list of contacts, etc.

The reward allocation table may comprise, for example, a list of activities for which a reward is offered, a list of completed activities, as well as the reward offered for each activity.

The reward condition table may comprise, for example, a list of activities for which a reward is offered, a list of rewards that have already been offered, and the conditions that must be met to provide a user with a reward.

The advertisement table may, for example, comprise a list of advertisements that may be provided to a user.

The advertisement condition table may, for example, comprise a list of advertisements that may be provided to a user as well as the conditions that must be met to provide each of the advertisements.

The database may comprise further tables comprising, for example, statistical information gleaned from the aforementioned tables.

The modules on the server 13 may update a table by providing information to the table. The activity data module 21, for example, may update the activity information table by providing the activity information table with an activity identifier. An administrator of the database may update, add, modify or delete information from the tables. The vendor terminal 11 and/or the mobile device 10 may further be operable to add, modify, delete, or obtain information from the tables. The vendor terminal 11 and/or the mobile device 10 may further be restricted from obtaining, adding, modifying, or deleting information from one or more of the tables or one or more portions of a table. If the server 13 is in communication with more than one vendor terminal 11, some vendor terminals may be provided with more restrictions than another vendor terminal 11. For example, a first vendor terminal 11 may be restricted from obtaining information relating to completed activities in a particular geographic area whereas a second vendor terminal 11 may be restricted from obtaining information relating to particular completed activities and instead may be provided with statistics relating to completed activities.

The mobile device 10 may obtain from the server 13 information regarding activity identifiers and/or personal identifiers associated with the user using the mobile device 10. For example, the mobile device 10 may be operable to obtain information relating to the products and venues that the user has scanned. The mobile device 10 may display the information to the user or provide the information to a display 5 through a display adapter. The information may comprise any information from the portions of the tables in the database 17 that are accessible to the mobile device 10. For example, the information may comprise a total of the accumulated rewards, digital receipts of purchases, information about sharing activity data and/or personal data, a list of all scanned items, an online store that enables a user to purchase items, statistics relating to the user's activity, etc. The mobile device 10 may further provide the user with an interface to enter settings including sharing settings and settings relating to payment for further items at an online store, and account information including account passwords.

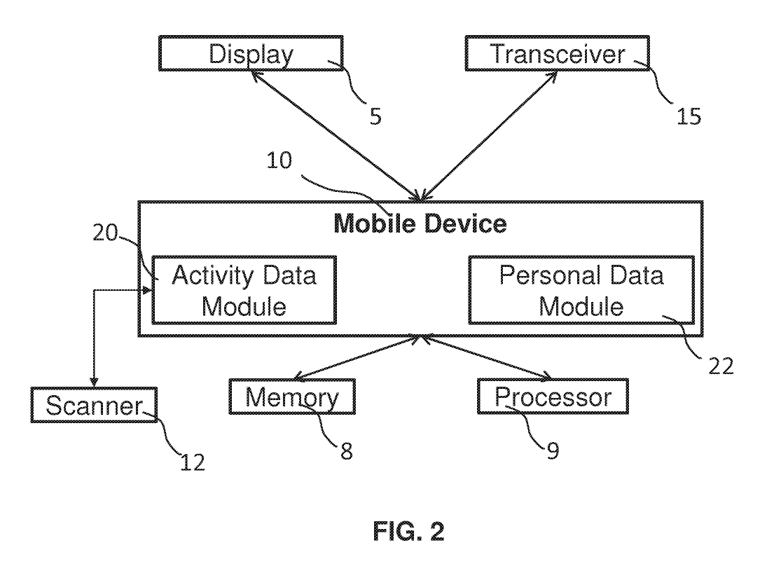

The vendor terminal 11 may obtain from the server 13 information regarding activity identifiers and/or personal identifiers associated with users. The server 13 may provide the vendor terminal 11 with all of the activity identifiers and/or personal identifiers. The server 13 may further restrict the activity identifiers and/or personal identifiers that are sent to the vendor terminal 11. For example, the server 13 may provide the vendor terminal 11 with activity identifiers associated with only users within a particular region of the vendor. Alternatively, the server 13 may provide the vendor terminal 11 with activity identifiers associated with only a specific type of product. The information provided to the vendor terminal 11 and/or the mobile device 10 may be current information or historical information. Referring now to FIG. 2, the mobile device 10 comprises an activity data module 20. The mobile device 10 may further comprise a personal data module 22. The scanner 12 is linked to the activity data module 20. The scanner 12 is operable to scan a token and provide token data to the activity data module 20 in the mobile device 10. The activity data module 20 is operable to process the token data to generate an activity identifier. The activity data module 20 may provide the activity identifier to an activity data module 21 on a server 13, as is further explained below.

For example, the activity data module 20 may be operable to process a digital photograph using image analysis techniques to extract activity information. The activity identifier may comprise an activity name, a description or identifier of the activity (e.g. scanning a product) and information relating to the activity (e.g. the name of a product, the date and time that the product was scanned, a product identification number, product expiry data, location data, etc.). The activity identifier may further comprise vendor information which may be provided to the mobile device 10 via a token supplied by the vendor and scanned by the user.

The mobile device 10 may further comprise a personal data module 22. The personal data module 22 may be operable to obtain personal data and generate a personal identifier. The personal data module 22 may provide the personal identifier to a personal data module 23 on a server 13, as is further explained below.

For example, if the user of the mobile device 10 has entered personal information into the mobile device 10 including age, location, gender, etc., the personal data module 22 may be operable to provide this information to the server 13. The personal data module 22 may compile information regarding services with which the user of the mobile device is associated. For example, if the user of the mobile device 10 is associated with a social media account, the personal data module 22 may provide information relating to the user's social media account to the server 13. For example, the personal data module 22 may provide the user's name on a social media network to the server 13. The personal data module 22 may be operable to obtain account information from the user's accounts, for example, the user's e-mail and/or the user's social media accounts. The personal data module 22 may incorporate the account information into the personal identifier. The personal data module 22 may further be provided with one or more user selectable options to determine which personal data the personal data module 22 can access and which personal data the personal data module 22 may provide to the server 13.

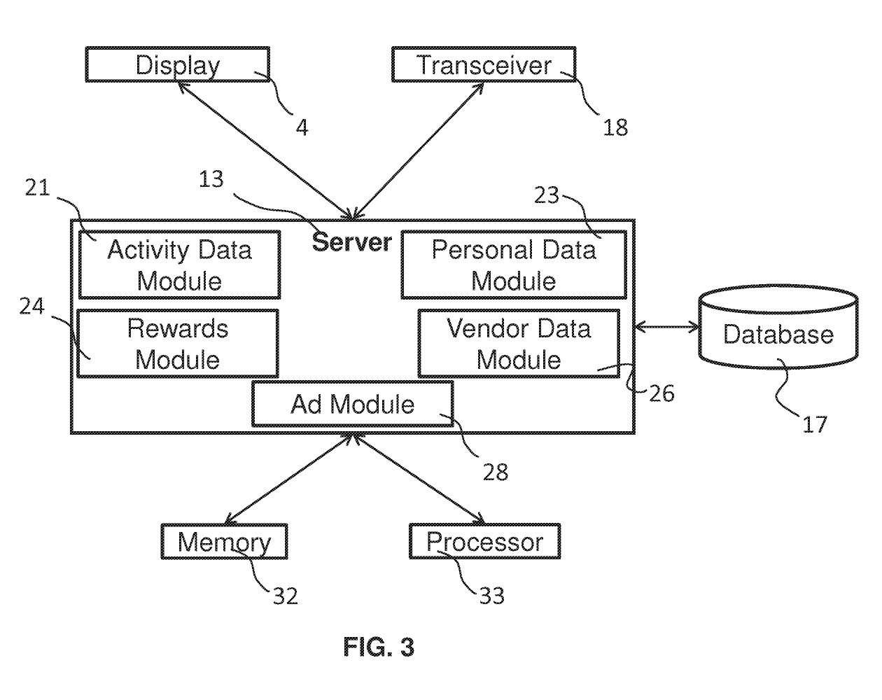

Referring now to FIG. 3, the server 13 may comprise an activity data module 21, a personal data module 23, a rewards module 24, a vendor data module 26, and an advertising module 28. The activity data module 21 on the server 13 is operable to obtain an activity identifier from the activity data module 20 in a mobile device 10 and to store the activity identifier in a table on the database 17. The activity data module 21 may further obtain information from the activity identifier and store the information in a table on the database 17.

The personal data module 23 on the server 13 is operable to receive a personal identifier from the personal data module 22 in a mobile device 10 and to store personal identifier on the database 17. The personal identifier may comprise demographic information, for example, a user's age, location, gender, etc. The personal identifier may further comprise account information (e.g. social media account information) which provides the server with information relating to a user account. For example, the personal identifier may comprise a user account number which identifies the user with information that was pre-stored on the database 17. The personal data module 23 on the server 13 may be operable to store the personal identifier in a table on the database 17. The personal data module 23 may further be operable to provide personal data to the rewards module 24. The vendor data module 26 is operable to identify a vendor using the product identifier.

The activity data module 21 on the server 13 may further be operable to store a list of activities and information associated with each activity on the database 17. For example, the activity may comprise a user purchasing a product, and the activity data module 21 may store a list of all the products being sold by a particular vendor as well as information specific to these products in a table on the database 17. The database 17 may be accessible and modifiable by one or more vendors through a vendor terminal 11. The database 17 may be accessible and modifiable by an administrator.

As stated above, when the scanner 12 provides token data to the activity data module 20, the activity data module 20 processes the token data to generate an activity identifier. The activity data module 20 then provides the activity identifier to the activity data module 21 on the server 13. The activity data module 21 on the server 13 may be operable to verify that the activity identifier corresponds to an activity stored in the activity information table on the database 17. If the activity data module 21 on the server 13 verifies that the activity identifier received from the mobile device 10 corresponds to an activity stored on the server 13, the activity data module 21 may provide activity data to the rewards module 24.

The rewards module 24 is operable to obtain one or more activity identifiers from the activity data module 21 and personal data from the personal data module 23. The rewards module 24 may compare the activity identifier and personal identifier with predetermined reward conditions in the reward condition table on the database 17 to determine whether a user should receive a reward. For example, the reward conditions may comprise information regarding the reward that a user should receive based on the user's personal information as well as the product information.

The vendor may publicize the reward conditions prior to the user's purchase. For example, the vendor may publicize the reward conditions in an advertisement. The reward conditions may be publicised using conventional advertisements, social media, or via ads on the mobile device 10. Alternatively, the vendor may maintain secrecy of the reward conditions to encourage the user to complete activities desirable to the vendor until the user discovers the reward conditions. The reward module 24 may be operable to reduce the reward received for completing a desirable activity if the user operating the mobile device 10 performs an undesirable activity.

The activity data module 21 on the server 13 may, for example, provide the mobile device 10 with a challenge activity stored in the activity information table on the database 17. The challenge activity may comprise, for example, a trivia quiz, a video game, or a challenge to take a photograph of a particular item. The reward module 24 may reward the user of the mobile device upon verification that the user has completed the challenge activity.

The reward module 24 may reward further activity. For example, the reward module 24 may reward a user for posting an item on a social media application and receiving a predetermined number of views. The reward module 24 may further be operable to provide a user with a gift reward if the user has not accomplished a predetermined activity.

The reward module 24 may be operable to provide a user with a reward for completing an activity that is beneficial to the vendor, the user, the environment, the user's friends and colleagues or society in general. The reward module 24 may be operable to provide a user with a reward for using a particular payment method. The reward module 24 may be operable to provide a user with a reward comprising points which may be redeemable at the online store. The reward module 24 may be operable to provide a reward to a user who has a relation to the user who has completed a desirable activity.

By way of example, a corner store may provide a promotion to those users who purchase a particular brand of soft drink each day. This promotion may be stored on the database 17 as a reward condition in the reward condition table. A user who purchases a soft drink may scan the soft drink using the mobile device 10 after purchasing the drink. As explained above, the scanner 12 provides a digitized token to the activity data module 20. The activity data module 20 then identifies the product and provides an activity identifier comprising the purchase location, purchase time and brand of the soft drink to the activity data module 21 on the server 13. The personal data module 22 on the mobile device 10 provides a personal identifier comprising the user's age to the personal data module 23 on the server 13. The activity data module 21 and the personal data module 23 on the server 13 may store the activity identifier and the personal identifier on the database 17.

The reward module 24 may verify whether the information in the personal identifier and the activity identifier meet the reward condition set by the vendor to distribute a reward to the user. The reward module 24 may then, upon verifying that the reward condition is met, provide the user with a reward. For example, the reward module 24 may provide a points credit redeemable for merchandise or as a credit to the user's bank account.

The reward module 24 may provide the user with a more desirable reward if the user interacts with another user who meets the reward conditions. For example, the users may scan each other's mobile devices to increase their rewards. The vendor may set other reward conditions, for example, the vendor may provide a reward to users who purchase then scan a product several times daily. The vendor may further provide a reward to users who share personal information with the vendor, or users who publish their purchases, for example, on social media.

A token may be provided on a product. A token may further be provided on an advertisement to verify and reward a user's recognition of an advertisement. A token may further be provided at venue. A token may comprise location information, vendor information, product information or any other relevant information. For example, a token such as a QR code provided at a venue may enable users to record their presence at a venue. The scanner 12 may further be operable to scan a token provided by a vendor at the point of sale, for example, in a token provided at the point of sale or on a receipt. The scanner 12 may further photograph the product or advertisement to generate corresponding token data.

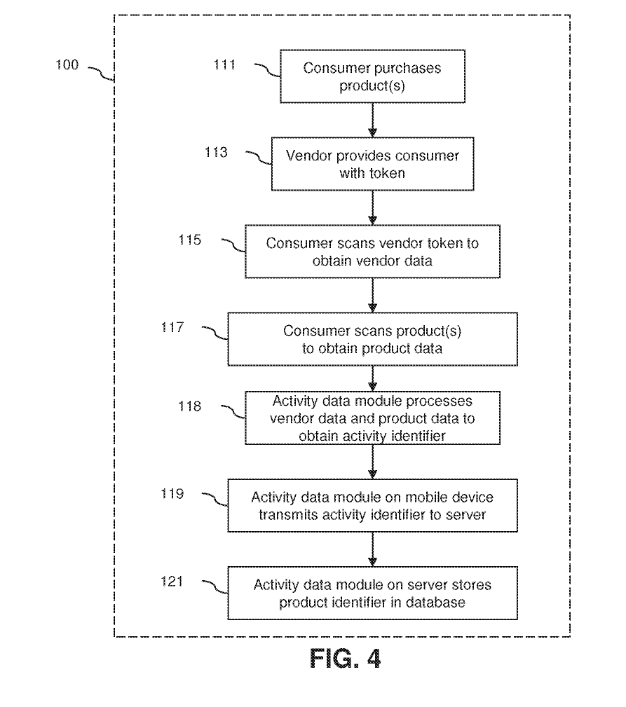

Referring to FIG. 4, a process flow diagram outlining a method of a user providing an activity identifier to the server 13, which when taken together, form step 100. In step 111, a user purchases a product. Next, in step 113, the vendor provides the user with a token. In step 115, the user scans the token with the scanner 12 to obtain token data, which is sent to the activity data module 20. The token provided by the vendor may be valid only for a predetermined period of time.

In step 117, the user scans an activity confirmation token with the scanner 12 to obtain token data which is then sent to the activity data module 20. For example, the activity confirmation token may comprise a token on a purchased product. If the user completes the activity of purchasing a product, the token may be scanned to verify the completion of the activity. If the vendor token expires prior to the user scanning the activity confirmation token, the activity data module 20 may disqualify the scanned items from being verified. The token data is processed by the activity data module 20 to generate an activity identifier in step 118. The activity data module 20 provides the activity identifier through the network 7 to the server 13 and received by the activity data module 21 on the server 13. The activity identifier may further be received by the vendor data module 26. The activity data module 21 on the server 13 may store the activity identifier on the database 17 to capture the purchase that the user has made. The vendor data module 26 may further store vendor data received from the activity identifier on the database 17.

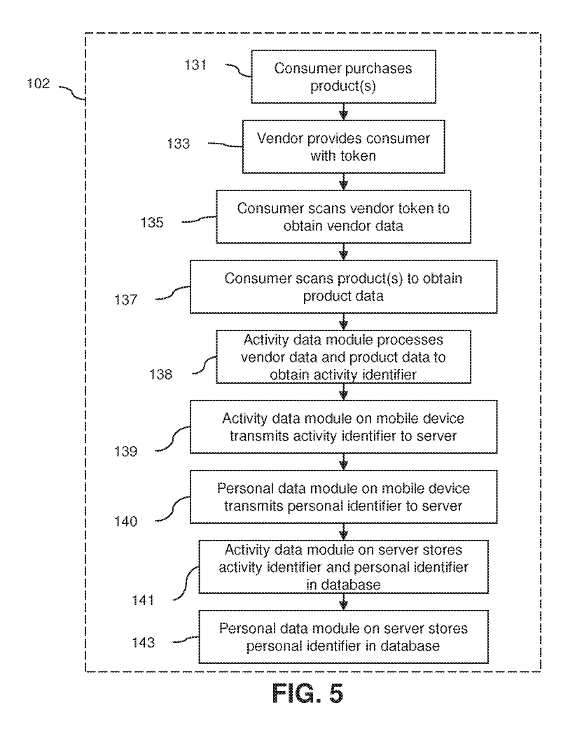

Referring now to FIG. 5, in which steps 131 to 139 correspond with steps 111 to 119 of FIG. 4 respectively. The personal data module 22 transmits a personal identifier to the server in step 140. The personal data module 22 may require the user to validate the user's identity and desire to share personal information in order for the personal data module 22 to be able to generate a personal identifier. In step 141, the activity data module 21 on the server 13 stores an activity identifier on the database 17. In step 143, the personal data module 23 stores the personal identifier on the database 17. The personal identifier may then be used to determine information relating to users who have completed a particular activity. The personal identifier may be used to contact a specific user of a product. Steps 131 to 143 taken together form step 102.

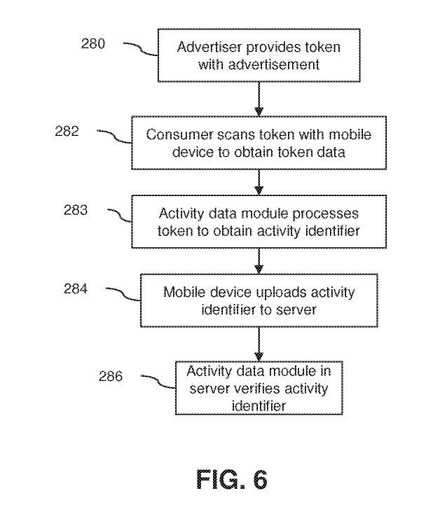

Turning to FIG. 6, a process flow diagram outlining the steps performed to verify recognition of an advertisement is shown. In step 280, an advertiser provides a token coupled to an advertisement. The token may, for example, be a QR code displayed on the advertisement. The user scans the token with a mobile device 10 in step 282 to obtain a token data. The activity data module processes the token data in step 155 to obtain an activity identifier, which is then sent to the server 13 in step 284. The activity data module 21 on the server 13 then verifies the activity identifier in step 286. The activity data module 21 may verify that the activity has been accomplished based on receipt of the activity identifier. The activity data module 21 may further compare the activity identifier to vendor information stored on the database 17 to verify the activity identifier. The activity data module 20 may crowd-source the verification of the activity. For example, the activity data module may request users of a social network to confirm the identity of the user in a photograph and/or verify that the user is performing a particular action. If enabled by the user, the server 13 may publish the user's attendance at the venue, for example, on a blog or over a social network. The rewards module 24 may provide a reward to the user provided the user's attendance meets the vendor's reward conditions.

The presence of a user at a venue may be verified by the system. The vendor may provide attendees of the venue with a token. For example, the vendor may provide attendees of the venue with a token. For example, a QR code may be displayed at the venue to be scanned as the attendees enter the venue. Rather than providing a token on an advertisement, as is done in step 280 of FIG. 6, a token may be provided at a venue. The method of verifying the user's attendance at the venue is performed following steps 282 to 286.

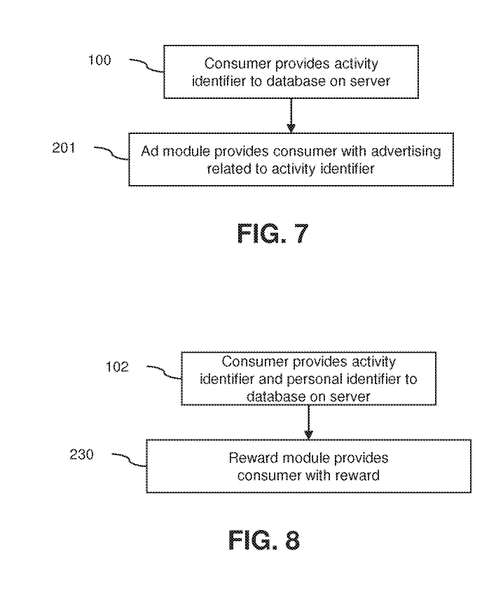

In one aspect, it may be advantageous for the vendor to provide a user with a targeted advertisement based on an activity identifier. Refer now to FIG. 7, which illustrates a method of providing a user with a targeted advertisement based on an activity identifier. The user provides an activity identifier to a database 17 on a server 13 in step 100. As mentioned above, step 100 may comprise a combination of the steps shown in FIG. 4. In step 201, the advertising module 28 provides an advertisement to the user related to the activity identifier. For example, if the user completed an activity, the advertising module 28 may provide an advertisement related to the completed activity.

In another aspect, it may be advantageous for the vendor to provide a user with a reward based on an activity identifier. For example, if a user's activity identifier indicates that the user had used public transit, the vendor may provide the user with a reward. Referring now to step 102 of FIG. 8, a user provides an activity identifier and a personal identifier to the database 17 on the server 13 according to the steps set out as shown in FIG. 5. In step 230, the reward module 24 verifies that the user's activity identifier and/or the user's personal identifier meet the reward conditions. If the reward conditions are met, the reward module 24 provides a reward to the user.

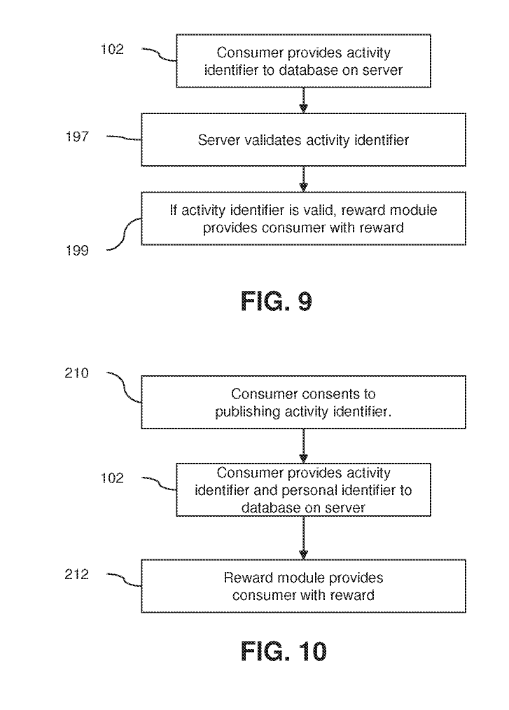

Turning to step 102 of FIG. 9, a user provides an activity identifier to the database 17 on the server 13 according to the steps set out in FIG. 5. In step 197, the server validates the activity identifier. The activity identifier may be validated based on information in any one or more of the tables stored on the database 17. The activity identifier may be validated using crowd-sourcing, as previously described. If the activity identifier can be validated, the reward module 24 may provide the user with a reward in step 199. The reward module 24 may verify whether the activity identifier meets predetermined reward conditions prior to delivering the reward to the user.

FIG. 10 shows a process flow diagram of a user being rewarded for consenting to having an activity identifier published. For example, the activity identifier may be published to a public website, a social media network. Alternatively, the publishing may comprise sharing the activity identifier or information stored in the activity identifier with one or more vendor terminals 11 that may not have previously had access to the activity identifier or the information within the activity identifier.

In step 210, the user provides consent for the activity identifier to be published. A personal identifier generated by the personal data module 22 may comprise the user's consent. In step 102, the activity data module 20 provides an activity identifier to the database 17 on the server 13, as is outlined in FIG. 5. In step 212, the reward module 24 rewards the user for providing consent to publish the user's activity identifier. By way of example, if a vendor generates a reward condition for users that publish activity relating to the user's purchases, the reward module 24 may provide a reward to the user.

1.-8. (canceled)

9. A system for verifying completion of an activity to control provision of rewards, the system comprising:
a database comprising: i) at least one activity information table providing one or more conditions to be satisfied to verify the activity, and ii) at least one reward table providing a list of one or more activities for which rewards are offered and any conditions to be met to provide a user with the rewards, wherein the database enables a plurality of vendors to offload administration of activity tracking and to provide rewards through the system using the activity and reward tables; and
a server in communication with the database and a network, the server comprising a processor and memory, the memory comprising computer executable instructions for determining activity information obtained from token data scanned by mobile devices associated with users seeking rewards and communicated to the server, comparing the activity information with the conditions provided in the at least one activity table to verify completion of an activity specified by one of the plurality of vendors providing rewards, comparing a verified activity with the list of activities in the at least one reward table to identify a reward, and providing the mobile device with an identified reward when the activity has been verified and associated with the reward.

10. The system of claim 9 further comprising:
an activity data module on the mobile device, in communication with the scanner; and
an activity data module on the server.

11. The system of claim 10 wherein the activity data module on the mobile device is operable to process the token data to generate an activity identifier and to provide the activity identifier to the activity data module on the server, and wherein the activity data module on the server is operable to verify the completion of the activity.

12. The system of claim 11 wherein the activity data module on the server is operable to compare the activity identifier to the conditions stored in the database to verify whether the activity identifier meets one or more predetermined activity conditions.

13. The system of claim 10, wherein the activity data module on the mobile device is configured to enable a user to interact with prebuilt conditional actions, time factors, and/or location factors to verify the completion of the activity.

14. The system of claim 9 further comprising a reward module operable to determine whether the verified activity meets one or more reward conditions or one or more co-dependent reward conditions; and upon determining that the activity meets the one or more reward conditions or the one or more co-dependent reward conditions, provide the identified reward to the user.

15. The system of claim 9, wherein at least one condition considers location and/or demographic information.

16. The system of claim 9, wherein the obtained token data is adjusted using data from at least one table in the database.

17. The system of claim 9, wherein the server database is configured to apply one or more verification methods in comparing the activity information with the conditions provided in the at least one activity table to track completion of activities.

19. The system of claim 9, wherein the verification of the activity is determined by the mobile device by communicating with another user.

19. The system of claim 11, wherein the token data is created by the user using a mobile device scanner and added to at least one table in the database.

20. The system of claim 11, wherein the mobile device is used by the user to interact with server-generated activities for generating the token data.

21. A method of verifying completion of an activity to control provision of rewards, the method comprising the steps of:
providing a database comprising: i) at least one activity information table providing one or more conditions to be satisfied to verify the activity, and ii) at least one reward table providing a list of one or more activities for which rewards are offered and any conditions to be met to provide a user with the rewards;
enabling a plurality of vendors to offload administration of activity tracking and to provide rewards using the activity and reward tables;
obtaining, at a server in communication with the database and a network, activity information communicated to the server by a mobile device associated with a user seeking a reward, the activity information being obtained from token data scanned by the mobile device of the user based on completion of an activity by the user;
the server comparing the activity information with the conditions provided in the at least one activity table to verify completion of an activity specified by one of the plurality of vendors providing rewards;
comparing a verified activity with the list of activities in the at least one reward table to identify a reward; and
providing the mobile device with the identified reward to the user when the activity has been verified and associated with the reward.

22. The method of claim 21 further comprising the step of determining the verified activity meets one or more reward conditions at a reward module on the server prior to providing the identified reward to the user.

23. The method of claim 21, wherein the activity information comprises an activity identifier generated by the mobile device from the token data.

24. The method of claim 21, wherein at least one condition considers location and/or demographic information.

25. The method of claim 21, further comprising having an activity data module on the mobile device enable a user to interact with prebuilt conditional actions, time factors, and/or location factors to verify the completion of the activity.

26. The method of claim 21, further comprising applying one or more verification methods to track completion of activities.

27. The method of claim 21, further comprising providing at least one server-generated activity to the mobile device, to generate the token data based on that server-generated activity.
